(19) United States
(12) Patent Application Publication
(10) Pub. No.: US 2026/0348288 A1
(43) Pub. Date: Nov. 5, 2026

(54) INTER-TURBINE CASING FOR A TURBINE ENGINE, TURBINE ENGINE ASSEMBLY, TURBINE ENGINE AND METHOD FOR POSITIONING A SPLITTER VANE WITHIN AN INTER-TURBINE CASING

(71) Applicant: SAFRAN AIRCRAFT ENGINES, Paris (FR)

(72) Inventors: Emanuele TAVOLO, Moissy-Cramayel (FR); Cyril VERBRUGGE, Moissy-Cramayel (FR)

(73) Assignee: SAFRAN AIRCRAFT ENGINES, Paris (FR)

(21) Appl. No.: 19/112,476

(22) PCT Filed: Sep. 15, 2023
(86) PCT No.: PCT/FR2023/051402

§ 371 Date: Mar. 17, 2025

(30) Foreign Application Priority Data
Sep. 19, 2022 (FR) 2209448

(51) Int. Cl. F01D 9/04; F01D 9/06

(52) U.S. Cl. CPC F01D 9/041; F01D 9/065; F05D 2220/3213; F05D 2240/129

(57) ABSTRACT

Inter-turbine casing for a turbine vane frame type turbomachine fulfilling the function of a turbine distributor in such a turbomachine, including an inner shroud, an outer shroud, a plurality of arms extending between the inner shroud and the outer shroud. At least one set of N splitter blades positioned circumferentially between two successive arms, each splitter blade having a mid-height axial chord shorter than the mid-height axial chord of the arms, in which said two successive arms define a reference position for each of said N splitter blades. These reference positions being evenly spaced circumferentially between the two successive arms, and in which at least one splitter blade of said set of N splitter blades is circumferentially offset relative to its reference position.

### TECHNICAL FIELD

The present disclosure generally relates to an inter-turbine casing for a turbine vane frame (TVF) type turbomachine fulfilling the function of a turbine distributor in such a turbomachine.

### PRIOR ART

In a manner known per se, a turbomachine comprises an inter-turbine casing arranged between the high-pressure turbine casing and the low-pressure turbine casing in a turbomachine. The inter-turbine casing comprises a fairing including an inner shroud and an outer shroud, which together delimit the flow path between the high-pressure turbine and the low-pressure turbine, as well as arms which extend radially between the inner shroud and the outer shroud.

The inter-turbine casing has both an aerodynamic function, as a stator for deflecting the incident stream coming from the high-pressure turbine, a structural function for transmitting mechanical forces between the inner shroud and the outer shroud, and an integration function for the passage of services. The fairing can therefore have a multi-profile configuration and include, in addition to the arms, splitter blades which have a reduced chord size compared to the arms, which are thicker and have a longer chord. The splitter blades and the downstream part of the arms thus ensure the aerodynamic function, while the arms ensure the structural and integration functions.

However, the wakes generated by the vanes of the inter-turbine casing (that is to say the thick arms and the splitter blades) are particularly wide and energetic. Particularly, the significant profile differences between the arms and the splitter blades lead to significant wake differences which lead to the occurrence of significant distortions of the flow downstream of the inter-turbine casing, these distortions being likely to disrupt the performance of the low-pressure turbine (aerodynamic losses, occurrence of detachments), to impact its mechanical strength (periodic excitations) or even to pose problems of integration of the low-pressure turbine (size of the low-pressure turbine).

There is therefore a real need to overcome the aforementioned drawbacks, by proposing a solution to improve the aerodynamic efficiency and therefore the efficiency of the low-pressure turbine in a turbomachine comprising an inter-turbine casing.

### DISCLOSURE OF THE INVENTION

The present disclosure relates to an inter-turbine casing for a turbomachine, comprising:
an inner shroud, centered on a central axis,
an outer shroud, coaxially surrounding the inner shroud,
a plurality of arms, each arm extending between the inner shroud and the outer shroud, having a leading edge and a trailing edge and having a mid-height axial chord, and
at least one set of N splitter blades positioned circumferentially between two successive arms, each splitter blade extending between the inner shroud and the outer shroud, having a leading edge and a trailing edge and having a mid-height axial chord shorter than the mid-height axial chord of the arms,
in which said two successive arms define a reference position for each of said N splitter blades, these reference positions being evenly spaced circumferentially between the two successive arms, and
in which at least one splitter blade of said set of N splitter blades is circumferentially offset relative to its reference position.

In other words, in the reference configuration, the azimuth Aᵢ of the reference position of the i^{th} splitter blade of said set of N splitter blades, that is to say its angular position about the central axis, can be written as follows: Aᵢ=A_{B1}+(A_{B2}−A_{B1})/(N+1), with A_{B1} the azimuth of the first arm and A_{B2} the azimuth of the second arm delimiting said set of N splitter blades.

Thus, in such a configuration according to the invention, unlike the conventional configuration usually found in the rotating machines, the splitter blades are not all evenly disposed between the arms.

Indeed, the inventors have observed that this reference configuration according to which the arms and the splitter blades are evenly spaced about the central axis generated significant distortions in the rate and orientation of the flow passing through the inter-turbine casing. Conversely, the inventors have determined that offsetting all or part of the splitter blades relative to their commonly accepted reference positions makes it possible to reduce the flow distortions, and therefore to increase the performance of the turbine downstream.

Thus, the invention is the result of technological research aimed at significantly improving the performance of the turbomachines and, in this sense, contributes to reducing the environmental impact of the aviation sector.

In some embodiments, the plurality of arms comprises between 4 and 20 arms.

In some embodiments, the arms are evenly distributed about the central axis. Their distribution is therefore axisymmetric.

In some embodiments, all the arms have the same profile.

In some embodiments, at least one arm is hollow, said at least one arm comprising a passage allowing the passage of a service of the turbomachine.

In some embodiments, said set of N splitter blades comprises between 1 and 4 splitter blades.

In some embodiments, the inter-turbine casing comprises a set of splitter blades between each successive arm.

In some embodiments, each set of splitter blades comprises the same number of splitter blades.

In some embodiments, the splitter blades are disposed in the same manner, relative to each other, in each set of splitter blades. Thus, the configuration of each set of splitter blades, that is to say the combination of the respective arrangements of each of their blades, constitutes a single pattern that is repeated identically between arms.

In some embodiments, all the splitter blades have the same profile.

In some embodiments, the mid-height axial chord of the splitter blades is at least 2 times shorter, preferably at least 3 times shorter, than the mid-height axial chord of the arms.

In some embodiments, the maximum thickness of the splitter blades is smaller than the maximum thickness of the arms.

In some embodiments, the maximum thickness of the splitter blades is at least 2 times shorter, preferably at least 3 times shorter, than the maximum thickness of the arms.

In some embodiments, the profile of at least a downstream portion of the splitter blades is identical to the profile of a downstream portion of the arms. The aerodynamic behaviors of the arms and of the splitter blades are thus similar, at least in the vicinity of their trailing edges, which reduces flow distortions.

In some embodiments, the trailing edges of the splitter blades are circumferentially aligned about the central axis with the trailing edges of the arms.

In some embodiments, the leading edges of the splitter blades are disposed further downstream than the leading edges of the arms.

In some embodiments, at least one splitter blade of said set of N splitter blades adjacent to an arm is circumferentially offset relative its respective reference position. This is preferably the case for both splitter blades of the set adjacent to an arm. This reduces the distortions caused by the profile difference of the arms.

In some embodiments, all the splitter blades of said set of N splitter blades are circumferentially offset relative to their respective reference positions.

In some embodiments, the circumferential offset of said at least one splitter blade which is circumferentially offset relative to its reference position is smaller in absolute value than 0.25×Δref, where Δref is the angular deviation between two consecutive reference positions. Preferably, no splitter blade has a circumferential offset relative to its reference position greater, in absolute value, than this limit. Indeed, the inventors have determined that the optimal offset area lies within this range.

In some embodiments, at least one splitter blade of said set of N splitter blades has a thickness different from the other splitter blades of said set of N splitter blades. Consequently, in such a case, the TE (trailing edge) trace stacking of the cross sections of the blade in question does not overlap with the TE trace stacking of the cross sections of the arm.

In some embodiments, at least one splitter blade of said set of N splitter blades has a different geometry, in particular by having a different stacking law, from the other splitter blades of said set of N splitter blades. Similarly, in such a case, the TE (trailing edge) trace stacking of the cross sections of the blade in question does not overlap with the TE trace stacking of the cross sections of the arm.

The present disclosure also relates to a turbomachine assembly, comprising:
an inter-turbine casing according to any one of the preceding embodiments, and
a turbine extending downstream of the inter-turbine casing and comprising at least one radially extending moving blade.

The present disclosure also relates to a turbomachine, comprising a turbomachine assembly according to any one of the preceding embodiments.

The present disclosure also relates to a method for positioning a splitter blade within an inter-turbine casing according to any one of the preceding embodiments, comprising the following steps:
providing an inter-turbine casing;
positioning splitter blades within the inter-turbine casing in their respective reference positions;
evaluating a parameter of the flow passing through the inter-turbine casing on either side of a given splitter blade and determining a reference distortion of this parameter;
moving said given splitter blade into one or more azimuthal positions circumferentially offset relative to its reference position; and
for each of these offset azimuthal positions:
   evaluating said parameter of the flow on either side of the given splitter blade (12-1),
   determining the distortion (Dd′) of this parameter, and
   comparing the distortion after displacement (Dd′) with the reference distortion (Dd), positioning the splitter blade within the inter-turbine casing at an offset azimuthal position which reduces the distortion of said parameter of the flow.

It is understood here that the steps of positioning, moving and evaluating the parameter can be carried out experimentally or numerically using a numerical simulation. An offset position is then retained for the given splitter blade which makes it possible to reduce, or even minimize, the distortion of the parameter of the flow.

In some embodiments, the parameter of the flow is evaluated as a function of the azimuthal position in a downstream radial plane.

In some embodiments, the step of evaluating the parameter of the flow after displacement is carried out for several different offset positions of the given splitter blade within an exploration range.

In some embodiments, the exploration range has an amplitude greater than 0.1×Δref and less than 0.25×Δref, where Δref is the angular deviation between two consecutive reference positions.

In some embodiments, these steps are repeated successively for each splitter blade of said set of N splitter blades.

In some embodiments, the evaluated parameter of the flow is the flow rate or the angle of the flow relative to the central axis.

In the present disclosure, the terms “longitudinal”, “transverse”, “lower”, “upper” and their derivatives are defined relative to the main direction of the blades; the terms “axial”, “radial”, “tangential”, “internal”, “external” and their derivatives are defined relative to the central axis of the inter-turbine casing, that is to say the main axis of the turbomachine; it is meant by “axial plane” a plane passing through the main axis of the turbomachine and by “radial plane” a plane perpendicular to this main axis; the terms “upstream” and “downstream” are defined relative to the circulation of air in the turbomachine; finally, the terms “front” and “back” mean in the circumferential direction when proceeding in a clockwise direction.

The above-mentioned characteristics and advantages, as well as others, will appear upon reading the following detailed description of exemplary embodiments of the inter-turbine casing and of the method proposed. This detailed description refers to the appended drawings.

### BRIEF DESCRIPTION OF THE DRAWINGS

The appended drawings are schematic and are intended primarily to illustrate the principles of the disclosure.

In these drawings, from one figure to another, identical elements (or parts of elements) are identified by the same reference signs.

FIG. 1 is an axial sectional plane of a turbomachine according to the invention.

FIG. 2 is a sectional view of a turbomachine assembly comprising one example of an inter-turbine casing and a turbine.

FIG. 3 is a partial perspective view of the example of a turbomachine assembly of FIG. 2.

FIG. 4 is a graph representing the flow rate as a function of the azimuthal position for a reference configuration and an offset configuration.

FIG. 5 is a graph representing the flow angle as a function of the azimuthal position for the reference configuration and the offset configuration of FIG. 4.

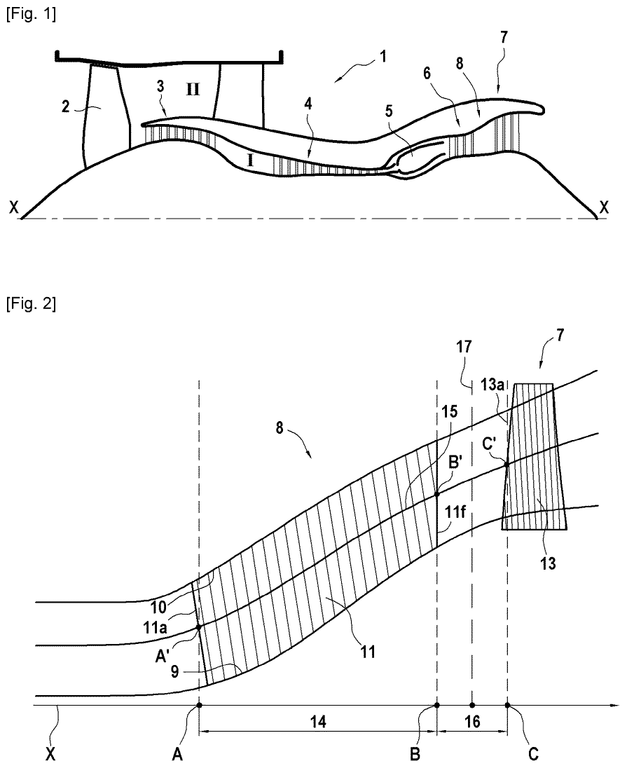

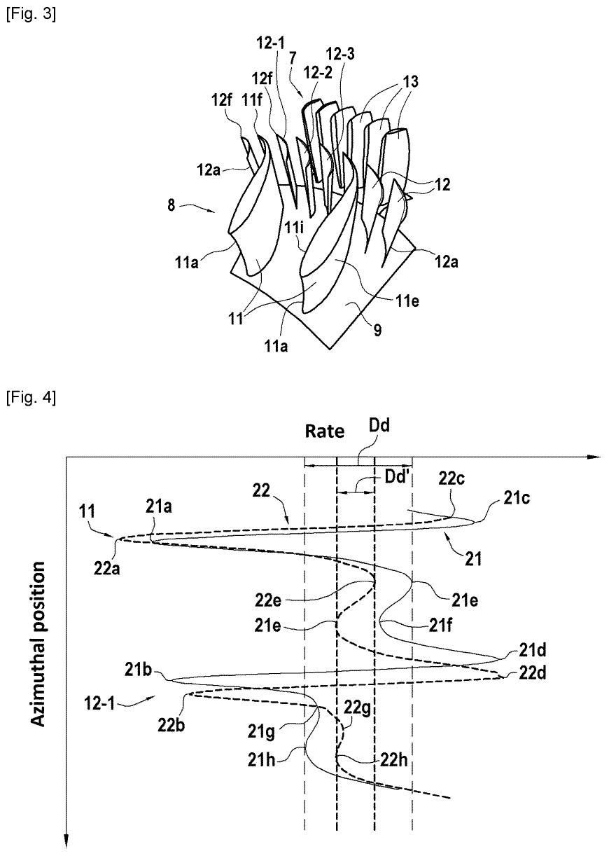

### DESCRIPTION OF THE EMBODIMENTS

In order to make the disclosure more concrete, one example of an inter-turbine casing is described in detail below, with reference to the appended drawings. It is recalled that the invention is not limited to this example.

A turbofan engine 1 (typically, an aircraft turbomachine 1) generally comprises, from upstream to downstream in the flow direction of the gases, a fan 2, a primary annular flow path I and a secondary annular flow path II. The air mass sucked in by the fan 2 is thus divided into a primary stream which circulates in the primary flow path I, and into a secondary stream which is concentric with the primary stream and circulates in the secondary flow path II.

The primary flow path I passes through a primary body comprising one or more compressor stages, for example a low-pressure compressor 3 and a high-pressure compressor 4, a combustion chamber 5, one or more turbine stages, for example a high-pressure turbine 6 and a low-pressure turbine 7 separated by an inter-turbine casing 8, and a gas exhaust nozzle.

In the present application, the upstream and the downstream are defined relative to the normal flow direction of the gases in the turbomachine 1. Moreover, the axis X is called the axis of rotation of the rotor of the low-pressure turbine 7, which coincides with the extension axis of the turbomachine 1. An axial direction corresponds to the direction of the axis X, a radial direction is a direction perpendicular to this axis X and passing through it. Moreover, a circumferential direction corresponds to a direction perpendicular to the axis X and not passing through it.

The inter-turbine casing 8 comprises an inner shroud 9 and an outer shroud 10 substantially coaxial with the axis X, and a fixed blade assembly comprising a plurality of arms 11 together forming a ring gear. The arms 11 extend from the inner shroud 9 to the outer shroud 10 and may be substantially radial relative to the axis X. Each arm 11 comprises a structural part, configured to transmit mechanical forces between the inner shroud 9 and the outer shroud 10, which is housed in an aerodynamically shaped wall.

The aerodynamic wall thus makes it possible to straighten the stream at the outlet of the high-pressure turbine 6 and to improve the supply of the low-pressure turbine 7, which is located immediately downstream of the inter-turbine casing 8.

The inter-turbine casing 8 may in particular comprise between four and twenty arms 11. In this example, the inter-turbine casing 8 comprises ten arms 11. Preferably, these arms 11 are evenly spaced about the axis X. The inter-turbine casing 8 also comprises a plurality of splitter blades 12 positioned circumferentially between the arms 11: a set of one or more splitter blades 12 is thus provided between each arm 11. It will be noted that, conventionally, the chord of each splitter blade 12 is shorter than the chord of each arm 11. The trailing edge 12f of each splitter blade 12 is aligned circumferentially with the trailing edge 11f of each arm 11; consequently, the leading edges 11a of the arms 11 are positioned further upstream than the leading edges 12a of the splitter blades 12. In addition, preferably, the downstream part of the arms 11 has a profile corresponding to at least one downstream part of the splitter blades 12.

The inter-turbine casing 8 may comprise between one and four splitter blades 12 between successive arms 11. Preferably, each set of splitter blades 12 comprises the same number of blades 12. In the present example, three splitter blades 12 are thus provided between each arm 11.

The low-pressure turbine 7 comprises, in a manner known per se, a plurality of turbine stages each comprising at least one moving blade 13. The low-pressure turbine 7 may comprise at least three turbine stages, for example between three and five turbine stages in the case of a turbomachine whose fan 2 is driven via a reduction mechanism. Since the low-pressure turbine 7 is conventional, it will not be detailed further here.

Each arm 11 has a mid-height axial chord 14. The mid-height axial chord 14 of a given arm 11 is defined from a mid-height line 15, which corresponds to the (imaginary) line comprised in a plane perpendicular to the axis X and which comprises all the points located midway between the inner shroud 9 and the outer shroud 10 and midway between the intrados 11i and the extrados 11e of the arm 11. The mid-height line 15 of a given arm 11 extends axially from the trailing edge of the row of fixed blades of the last stage of the high-pressure turbine 6 immediately upstream of the inter-turbine casing 8 to the leading edge 12a of the moving blade 12 of the low-pressure turbine 7 located immediately downstream of the inter-turbine casing 8. The mid-height axial chord 13 then corresponds to the length of the straight line segment connecting the points A and B, which correspond respectively to the projection on the axis X of the point A′ located at the intersection between the mid-height line 15 and the leading edge 11a of the arm 11, and of the point B′ located at the intersection between the mid-height line 15 and the trailing edge 11f of the arm 11.

Similarly, each splitter blade 12 has a mid-height axial chord measured by projecting onto the axis X the points located at the intersection between the mid-height line 15 and the leading edge 12a of the splitter blade 12, and at the intersection between the mid-height line 15 and the trailing edge 12f of the splitter blade 12.

Finally, the arm-blade distance 16 corresponds to the axial distance, measured at mid-height of the arm 11, between the trailing edge 11f of the arm 11 and the leading edge 13a of a moving blade 13 immediately downstream of the arm 11, that is to say at the length of the straight line segment connecting the points B (defined above) and C, where the point C corresponds to the projection on the axis X of the point C′ located at the intersection between the mid-height line 15 and the leading edge 13a of the moving blade 13. It will be noted here that the arm-blade distance 16 can be measured for any moving blade 13 of the most upstream stage of the low-pressure turbine 7 (generally referred to as “first stage” of the low-pressure turbine), insofar as the moving blades 13 are symmetrical of revolution about the axis X so that, whatever the moving blade 13 selected in this stage, the projection on the axis X of the point at the intersection between the mid-height line 15 and the leading edge 13a of the moving blade 13 is identical and coincides with the point C.

From then on, the downstream TVF plane 17 is defined, which is the plane perpendicular to the axis X at 50% of the arm-blade distance 16, that is to say halfway between points B and C.

One example of a method for positioning the splitter blades 12 will now be described.

This method aims to adjust the azimuth, that is to say the angular position about the axis X, of each splitter blade 12. Preferably, all the sets of splitter blades 12 have the same configuration, that is to say the same combination of azimuths for each of their splitter blades 12: in other words, the i^{th} splitter blade 12 of a set is always located at the same angular distance from the arm 11 preceding it. Therefore, in this example, the method seeks to adjust the azimuth of the splitter blades 12 of a single given set and then the combination of the azimuths obtained for this set will be reproduced identically for the other sets.

That being said, a reference position is first calculated for each splitter blade 12 of the set considered. This reference position corresponds to the position that the splitter blade 12 would have in the classic configuration of the equal distribution about the axis X, that is to say the reference configuration in which the deviation between the splitter blades 12 or between a splitter blade 12 and its adjacent arm 11 is always equal. In the present example, with ten arms 11 and three splitter blades 12 per arm 11, it can be calculated that this regular deviation is equal to 360°/(10×(3+1))=9°. Therefore, if the arm 11 preceding the set of splitter blades 12 considered in the clockwise direction has the azimuth 0°, the reference position of the 1^{st} splitter blade 12-1 will be 9°, the reference position of the 2^{nd} splitter blade 12-2 will be 18°, and the reference position of the 3^{rd} splitter blade 12-3 will be 27°.

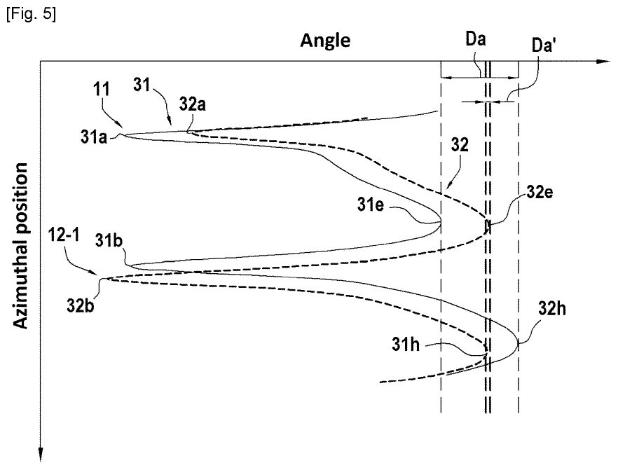

A numerical simulation, or an experiment on a test bench, is then conducted in the reference configuration in order to measure the flow rate passing through the inter-turbine casing 8 as a function of the azimuthal position in the downstream TVF plane 17, at least along the angular sector separating the two arms 11 framing the set of splitter blades 12 considered. A curve 21 as represented on the graph of FIG. 4 is then obtained (this graph is represented here in a partial way, centered on the first blade 12-1 of the set considered since it is the first blade that is to be positioned).

On this curve 21, it should be understood that the minimum 21a corresponds to the reduction of the stream in the extension of the arm 11, while the minimum 21b corresponds to the reduction of the stream in the extension of the first blade 12-1, which makes it possible to identify them. It is also noted that the presence of the arm 11 and of the blade 12-1 causes respectively rate peaks 21c and 21d on their intrados side. In addition to these extrema 21a-21d directly caused by the presence of the arms 11 and of the splitter blades 12, the presence of a local maximum 21e followed by a local minimum 21f between the arm 11 and the first blade 12-1 as well as the presence in a similar manner of a local maximum 21g followed by a local minimum 21h at the front of the first blade 12-1 in the clockwise direction, are noted.

The rate distortion Dd between the front and the back of the blade 12-1, constituting a reference distortion, is then measured between the maximum rate 21e at the back of the first blade 12-1 in the clockwise direction and the minimum rate 21h at the front of the first blade 12-1 in the clockwise direction.

The first blade 12-1 is then moved forward and/or backward from its reference position, preferably in a range deviating by a maximum of 0.25 times the normal angular deviation, namely 0.25×9°=2.25° in the present example. Thus, in the present example, several positions can be tested for the first blade 12-1 between the azimuth 6.75° and 11.25°.

For each tested position, a numerical simulation or an experiment on a test bench is again conducted in order to measure the flow rate passing through the inter-turbine casing 8 as a function of the azimuthal position in the downstream TVF plane 17, at least on either side of the first blade 12-1. The curve 22 as represented in the graph of FIG. 4 is then obtained.

Extrema 22a-22h similar to those of the curve 21 of the reference configuration but whose positions are offset are then found. Especially, it is noted that the minimum 22b and the maximum 22d are offset forward in the clockwise direction, which reveals that the blade 12-1 has been moved forward in the clockwise direction relative to its reference position.

In a similar manner to what was done for the reference configuration, the rate distortion Dd′ is then measured in this offset configuration between the maximum rate 22e at the back of the first blade 12-1 and the minimum rate 22h at the front of the first blade 12-1. It is then observed that the offset of the blade 12-1 made it possible to significantly reduce this rate distortion Dd′.

It is then possible to retain the tested position which makes it possible to minimize the rate distortion Dd′. Then, once the optimal position of the first blade 12-1 has thus been determined, the same steps can be carried out to determine the optimal position of the second blade 12-2 by focusing on the rate distortion between the back and the front of the second blade 12-2. And so on for all the splitter blades 12 of the set.

Alternatively or complementarily, it is also possible to perform these positionings based on another parameter of the flow and especially the angle of the flow relative to the axis X as measured at the downstream TVF plane 17, as represented in FIG. 5.

Thus, the curve 31 of FIG. 5 represents the curve of the angle of the flow as a function of the azimuthal position in the downstream TVF plane 17 in the reference configuration, while the curve 32 represents the curve of the angle of the flow in the offset configuration.

On these curves, the minima 31a and 32a make it possible to identify the arm 11 while the minima 31b, 32b make it possible to identify the first blade 12-1. The flow angle distortion Da, Da′ is measured between the maximum 31e, 32e at the back of the first blade 12-1 and the maximum 31h, 32h at the front of the first blade 12-1, in the clockwise direction. It can thus be noted that the offset of the first blade 12-1 made it possible to significantly reduce the angle distortion Da′ relative to the angle distortion Da in the reference configuration.

In one variant of embodiment, in addition to a circumferential offset of at least one splitter blade, it is also possible to modify the thickness of a splitter blade. This modification can relate to a circumferentially offset blade as well as to a blade that has not been circumferentially offset.

In another variant of embodiment, in addition to a circumferential offset of at least one splitter blade, it is also possible to modify the stacking law of a splitter blade. This modification can relate to a circumferentially offset blade as well as to a blade that has not been circumferentially offset.

Although the present invention has been described with reference to specific exemplary embodiments, it is obvious that modifications and changes can be made to these examples without departing from the general scope of the invention as defined by the claims. Especially, individual characteristics of the various embodiments illustrated/mentioned can be combined in additional embodiments. Consequently, the description and the drawings should be considered in an illustrative rather than restrictive sense.

It is also obvious that all the characteristics described with reference to one method are transposable, alone or in combination, to one device, and conversely, all the characteristics described with reference one a device are transposable, alone or in combination, to one method.

1. An inter-turbine casing for a turbomachine, comprising:
an inner shroud, centered on a central axis,
an outer shroud, coaxially surrounding the inner shroud,
a plurality of arms, each arm extending between the inner shroud and the outer shroud, having a leading edge and a trailing edge and having a mid-height axial chord, and
at least one set of N splitter blades positioned circumferentially between two successive arms, each splitter blade extending between the inner shroud and the outer shroud, having a leading edge and a trailing edge and having a mid-height axial chord shorter than the mid-height axial chord of the arms,
wherein said two successive arms define a reference position for each of said N splitter blades, these reference positions being evenly spaced circumferentially between the two successive arms, and
wherein at least one splitter blade of said set of N splitter blades is circumferentially offset relative to its reference position.

2. The inter-turbine casing according to claim 1, wherein the arms are evenly distributed about the central axis.

3. The inter-turbine casing according to claim 1, wherein at least one arm is hollow, said at least one arm comprising a passage allowing the passage of a service of the turbomachine.

4. The inter-turbine casing according to claim 1, comprising a set of splitter blades between each successive arm,
wherein each set of splitter blades comprises the same number of splitter blades, and
wherein the splitter blades are disposed in the same manner, relative to each other, in each set of splitter blades.

5. The inter-turbine casing according to claim 1, wherein the profile of at least a downstream portion of the splitter blades is identical to the profile of a downstream portion of the arms, and
wherein the trailing edges of the splitter blades are circumferentially aligned about the central axis with the trailing edges of the arms.

6. The inter-turbine casing according to claim 1, wherein all the splitter blades of said set of N splitter blades are circumferentially offset relative to their respective reference positions.

7. The inter-turbine casing according to claim 1, wherein the circumferential offset of said at least one splitter blade which is circumferentially offset relative to its reference position is smaller in absolute value than 0.25×Δref, where Δref is the angular deviation between two consecutive reference positions.

8. The inter-turbine casing according to claim 1, wherein at least one splitter blade of said set of N splitter blades has a thickness different from the other splitter blades of said set of N splitter blades.

9. The inter-turbine casing according to claim 1, wherein at least one splitter blade of said set of N splitter blades has a different geometry, in particular by having a different stacking law, from the other splitter blades of said set of N splitter blades.

10. A turbomachine assembly, comprising:
an inter-turbine casing according to claim 1, and
a turbine extending downstream of the inter-turbine casing and comprising at least one extending radially moving blade.

11. The assembly according to claim 10, wherein the turbine comprises an impeller, carrying a plurality of moving blades, located immediately downstream of the inter-turbine casing.

12. A turbomachine, comprising a turbomachine assembly according to claim 10.

13. A method for positioning a splitter blade within an inter-turbine casing according to claim 1, comprising the following steps:
providing an inter-turbine casing;
positioning splitter blades within the inter-turbine casing in their respective reference positions;
evaluating a parameter of the flow passing through the inter-turbine casing on either side of a given splitter blade and determining a reference distortion of this parameter;
moving said given splitter blade into one or more azimuthal positions circumferentially offset relative to its reference position; and
for each of these offset azimuthal positions:
evaluating said parameter of the flow on either side of the given splitter blade,
determining the distortion of this parameter, and
comparing the distortion after displacement with the reference distortion,
positioning the splitter blade within the inter-turbine casing at an offset azimuthal position which reduces the distortion of said parameter of the flow.
